(19) United States
(12) Patent Application Publication
(10) Pub. No.: US 2020/0165696 A1
(43) Pub. Date: May 28, 2020

(54) METHOD FOR OPERATING A CONTINUOUS PROCESSING LINE

(71) Applicant: TATA STEEL NEDERLAND TECHNOLOGY B.V., VELSEN-NOORD (NL)

(72) Inventor: Hai WU, Eindhoven (NL)

(73) Assignee: TATA STEEL NEDERLAND TECHNOLOGY B.V., VELSEN-NOORD (NL)

(21) Appl. No.: 16/630,055

(22) PCT Filed: Jul. 11, 2018
(86) PCT No.: PCT/EP2018/068824

§ 371 Date: Jan. 10, 2020

(30) Foreign Application Priority Data
Jul. 12, 2017 (EP) 17180898.3

(51) Int. Cl. C21D 9/56; C21D 11/00; C21D 8/04; G05B 13/04

(52) U.S. Cl. CPC C21D 9/56; C21D 11/00; G05B 2219/45234; C21D 8/0405; G05B 13/048; C21D 8/0447

(57) ABSTRACT

A method for operating a continuous processing line including an annealing step for the production of continuously processed rolled steel strip using a computer aided dynamic property predictive control model.

This invention relates to a method for operating a continuous processing line.

A continuous processing line (CPL) consists of various process steps including typically, and not in any particular order, annealing, hot-dip coating, temper rolling and tension levelling. Together these process steps serve multiple processing purposes to deliver strip products in good mechanical, surface and geometry properties in both intermediate states and in its final state. Failing to satisfy an intermediate state jeopardises the subsequent processes and related properties. It results in downgrades or rejections as the end product concerns and economical penalties. So the control of the process settings has become increasingly important to attempt to control the final properties of the end product. Lately the focus has shifted from process control only to property control of the end product. Control models linking process setting to resulting properties have become increasingly important as a result, and usually these control models rely on the input of sensors which measure one or more process parameter, such as temperature or thickness.

The property control based on the sensor measurement placed at the end of the process sections, as disclosed in WO2014187886, incurs a large dead time in the control loop due to the transportation of the strip in the lengthy passage through the line. It can lead to substantial material losses before the control detects and remedies the deviations. For some situations, a strip in short length e.g. already passes the critical heat-treatment temperature regime before the strip head reaches the property measuring point. The control is thus not effective and can be too late to act.

The property control based on the model prediction, as disclosed in EP2742158, provides a solution to compensate the dead time in the control loop. It uses a property model to online predict the properties based on the process histories and to adjust the remaining processes in the line, if necessary, to remedy otherwise quality deviations based on the prediction. It does not, however, consider the forthcoming process dynamics, constraints and disturbances imposed by the scheduled strip transitions. From the production practice it is known that these operational parameters can be a dominating factor of whether the process pre-sets, determined by the property model or the empirical routine, are realistic and achievable. Therefore without considering the forthcoming process circumstances, the control actions that are solely determined by the property model can be poorly judged, infeasible, and lead to instable operation. For example, the annealing of a thick strip A followed by a thin strip B requires an increase in the line speed to compensate the temperature overshoot that would occur otherwise at the thickness transition and to minimise the risk of heating buckles. But the galvanising process following the annealing needs to decrease the line speed from the same strip A with a high coating thickness target to the strip B with a low coating thickness due to the limitation in the gas pressure of the wiping process, or in case of electroplating, due to desired differences in plating layer thickness. Such conflict cannot be solved satisfactorily by the property models.

The feedstock of a continuous processing line, which end products for example serve the automotive market or the packaging market, is diverse in terms of the strip dimensions, the material chemistries, the entry conditions and in-strip spatial inhomogeneities as created by the prior processes, the end product properties and hence process requirements. Possible combinations of all these factors form endless variations in the process requirements varying from order to order and further from strip to strip. In a time where just in time delivery is commonplace, the size of individual orders decreases. It is therefore common that to a considerable extent the process in the continuous processing line is in a transient and therefore dynamic state. The task to mitigate the impact of the transient process conditions on the product properties demands skilful operators and their constant attentions. A control method or automation system without properly considering or more preferably predicting the forthcoming dynamics of the processes can result in improper control advices, actions and hence suboptimal results.

The problem with the current process control systems is that the classical set-up and feed-back models are only adequate in a situation where a lot of material is produced that is more or less the same. In this case the changes between subsequent coils are minimal in terms of mechanical, surface and geometry properties. However as a result of the sketched developments the batch size decreases to such an extent that unique strips are more and more being produced, which may even have transient mechanical, surface and geometry properties over the length. With the classical set-up and feed-back this means that e.g. a change in annealing temperature will not be in time for the head of the strip. This long dead time results in a potentially downgraded product, and thus in loss of yield.

It is an object of the invention to provide a method which reduces the dead time in the process control of a continuous processing line.

It is another object of the invention to provide a method which is able to produce continuously processed end products with an improved yield.

It is another object of the invention to provide a method which is able to produce continuously processed end products with tighter tolerances for mechanical, surface and/or geometric properties.

It is another object of the invention to provide a method which is capable of dealing with the dynamics of process control in modern production of continuously processed steels.

One or more of these objects are reached with a method for operating a continuous processing line (CPL) comprising an annealing step for the production of continuously processed rolled steel strip using a computer aided dynamic property predictive control model (DPPC) comprising a material property model (MPM) and a dynamic process model (DPM), wherein the output of the MPM is used as input parameters for the DPM to enable the DPM to provide final process settings (FPS) for the CPL, and wherein the input parameters for the MPM comprise:
one or more elements of the production schedule
target values for a segment of the incoming rolled strip for the mechanical, surface and/or geometry properties
one or more parameters of prior process conditions and/or predicted or measured mechanical, surface and/or geometry properties of said segment
(optionally) one or more elements of the chemical composition of said segment of the steel strip
(optionally) one or more microstructural parameters of said segment of the incoming rolled strip
(optionally) installation condition parameters
(optionally) feedback parameters from on-line property measurements of the incoming rolled strip
(optionally) feedback parameters from off-line property measurements

and wherein the input parameters for the DPM comprise
the output of the MPM

and one or more of:
installation condition parameters
one or more of the input parameters for the MPM
(optionally) feedback from on-line CPL process measurements
   to produce the FPS for the segment of the steel strip and wherein the FPS for the segment are fed into the CPL computerised process automation, whereby the segment of the steel strip is subsequently produced and satisfies the target mechanical, surface and/or geometry properties.

Examples of prior process conditions may be the coiling temperature of a segment, or the reduction in the cold-rolling mill.

It should be noted that if the mechanical, surface and/or geometry properties of a segment of the incoming rolled strip are accurately predicted or measured, the MPM may not require input relating to chemical composition or prior process conditions or microstructural parameters. The output of the MPM, in addition with one or more of the installation condition parameters, one or more of the input parameters for the MPM (e.g. the schedule) and (optionally) feedback from on-line CPL process measurements are provided to the DPM to predict the FPS with the DPM.

Preferred embodiments are provided in the dependent claims.

With the method according to the invention the dead time issue in the control loop is effectively addressed. Also the knowledge and prediction of the forthcoming process dynamics, constraints and disturbances imposed by the scheduled strip transitions are effectively included as well as the knowledge and prediction of the impact on the product properties of the forthcoming process dynamics, constraints and disturbances imposed by the scheduled strip transitions. By iteratively examining the properties prediction and the processes prediction against the properties targets and operational targets the process control is optimised. The integration of the annealing and the optional coating, temper rolling, tension levelling processes and coating process to enable the CPL to produce strips with excellent quality including mechanical, surface and geometry properties. The method according to the invention is based upon the determination of process settings for a segment of strip. The length of such a segment can be different from strip to strip. One strip may comprise only one segment, or a multitude of segments. The number of segments needed per strip is determined by the DPPC on a case by case basis, or is provided by the previous processes. For example, the DPPC may use the same segments as the preceding hot-rolling process.

The process schedule is the succession of strips that are to be produced. Each strip has its own set of properties such as strip dimensions (e.g. width, length, thickness), the chemical composition, the entry conditions and in-strip spatial inhomogeneities as created by the prior processes (hot rolling, pickling and cold rolling, etc.), the target mechanical, surface and geometry properties. To reach the target mechanical, surface and geometry properties the process settings for the continuous processing line must be chosen carefully, also taking into account the preceding installation and process conditions.

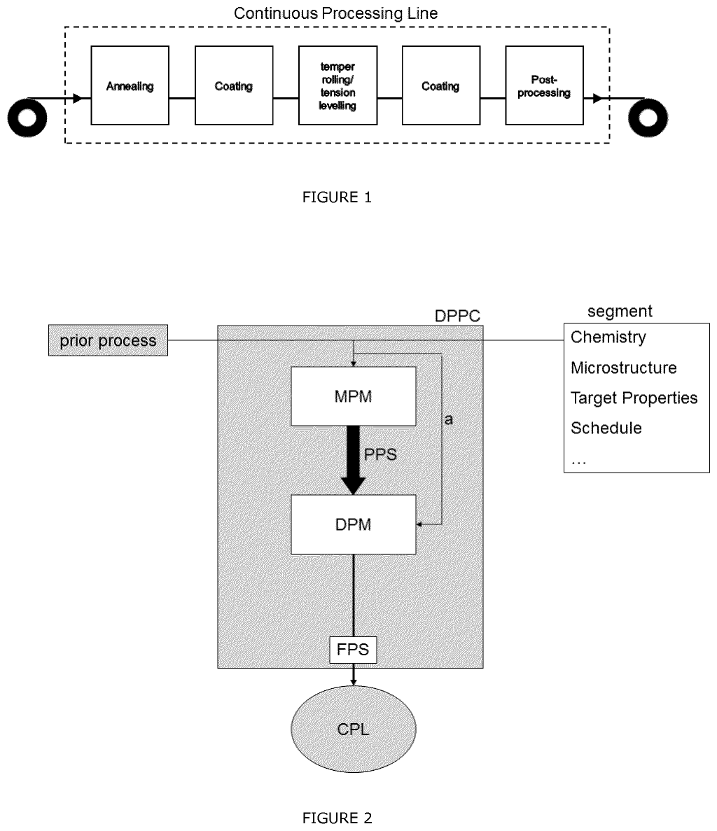

FIG. 1 shows a schematic representation of a continuous processing line (dashed box). The CPL may comprise of a combination of process steps as depicted therein, wherein the strip segments travel from left to right. In its most limited embodiment the CPL would consist of a continuous annealing step only. However usually such a continuous annealing step would be followed by a temper rolling step and/or a post-processing step such as oiling or a lubricant. In many cases the continuously annealed strip is coated in a hot-dip coating process, or an electroplating process, and may subsequently be temper rolled and/or coated with an organic or inorganic coating. The flexibility of the method according to the invention is such that the DPPC can be tailored to each CPL.

It is noted that the order in FIG. 1 is a common order of process steps, but the method according to the invention also allows for different orders. It is envisageable that coating with a metallic coating can take place in a first coating step, followed by temper rolling and a second coating step with organic coating or an inorganic coating, or metallic coating, followed by organic coating, followed by temper rolling.

FIG. 1 shows the mandatory annealing step and the optional subsequent process steps:
a continuous annealing step (mandatory)
a first coating process
a temper-rolling and/or tension levelling process
a second coating process
a post-processing step In an embodiment the first and/or second coating step is a hot-dip coating process or an electroplating process.

In an embodiment the DPPC also provides the FPS for the CPL automation of the thickness control of the hot dip coating layer.

In an embodiment the first and/or second coating step is an organic coating step.

In an embodiment the first and/or second coating step is an inorganic coating step. In a preferred embodiment the inorganic coating step comprises or consists of a physical vapour deposition (PVD) process.

The post-processing step may comprise processes such as passivation, oiling, etc.

In FIG. 2 the Dynamic Property Predictive Control (DPPC) model is schematically presented. By inputting relevant prior process parameters, target mechanical, surface and geometry properties, production schedule, microstructure, chemistry etc. the Materials Property Model (MPM) predicts a set of preliminary process settings (PPS) with which the target mechanical, surface and geometry properties for a segment of strip can be obtained according to the MPM. These PPS (represented with the thick black arrow in FIGS. 2 to 4) are offered up to the Dynamic Process Model (DPM) which determines whether these PPS can be realised in the CPL. If this is indeed the case then these PPS are passed from the DPPC to the control systems of the CPL as the final process settings (FPS). The line tagged “a” in FIGS. 2 to 4 illustrates that the DPM may also use one or more input parameters for the MPM in the calculation of the FPS.

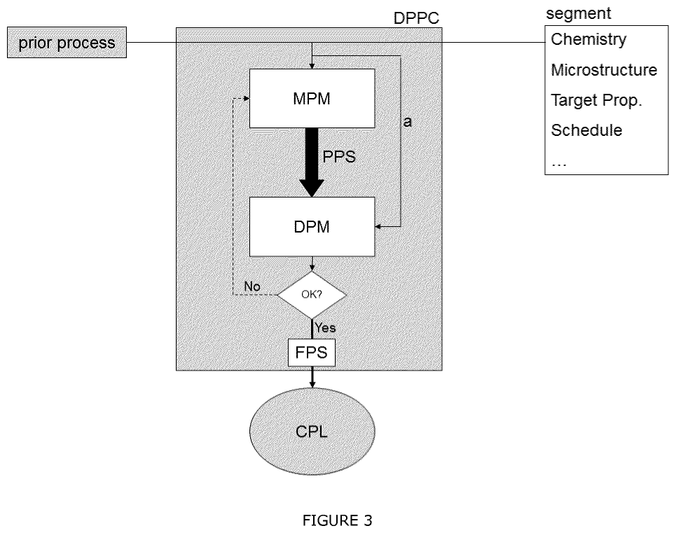

If the DPM decides that the desired process settings as proposed by the MPM cannot be realised in the CPL, then an iterative process is initiated wherein the MPM, based on what is realisable proposes a new set of process parameters to the DPM, just as long as it takes to arrive at the best solution, which is then passed on to the control systems of the CPL. The best solution is the solution where the difference between the target properties and the achievable properties is lower than a pre-set minimum. As long as this pre-set minimum is not reached, the iteration as shown in FIG. 3 by the dashed line is repeated. If the minimum is not reached at all, then the introduction of a dummy strip in the schedule between two appropriate strips may be recommended by the DPPC wherein the dummy strip serves as a sacrificial strip, allowing for a certain transience in process conditions to be achieved while running the dummy strip through the CPL so that when the first segment of the next strip enters the CPL that the FPS are optimal for the realisation of the target properties of the segment.

The DPM is used to predict forthcoming process conditions. The model describes the states and dynamics of the installations and processes including the heat transfer during the annealing, the gas-metal reaction on the strip surface, and if applicable, the hot-dip coating process, the wiping process after the hot-dip coating, the temper rolling, and/or the tension levelling.

The MPM is used to predict the intermediate and final state of the strip properties including the mechanical properties (grain size, yield strength, tensile strength, elongation, phase fraction, etc.), the external/internal oxidation and surface wettability for hot dip coating, and/or the geometry (surface roughness, shape) based on input process conditions.

These calculations are performed in real time to determine the process settings (and tolerances) based on the process and property predictions for the given production schedule.

It is necessary to optimise the process settings so that the target mechanical, surface and geometry properties of the multiple strips in sequence can be realised in acceptable consistency, and the process variations and dynamics as demanded by the process settings are executable and meet the operational targets.

If any of the requirements is violated, an exception or alarm is raised to notify the deviations. It may lead to a re-scheduling of the production sequence or a request for a dummy or non-constrained strip if economically favourable. This may for instance be the case if a very big difference in annealing temperature is required from one strip to the next. If a rescheduling is not possible, then a dummy strip may be entered between these two strips, and the dummy strip then serves as a sacrificial strip.

The invention employs both process models and property models to predict the forthcoming production, including multiple strips and consecutive transitions, given the production schedule. It is the only way to be able to forecast the course of the process as much close to reality as possible, and upon that to optimise the process settings and compute the control actions to meet the multiple processing purposes and production goals simultaneously. By doing so, the hit rate of the said production can be maximised to yield strip products with excellent properties.

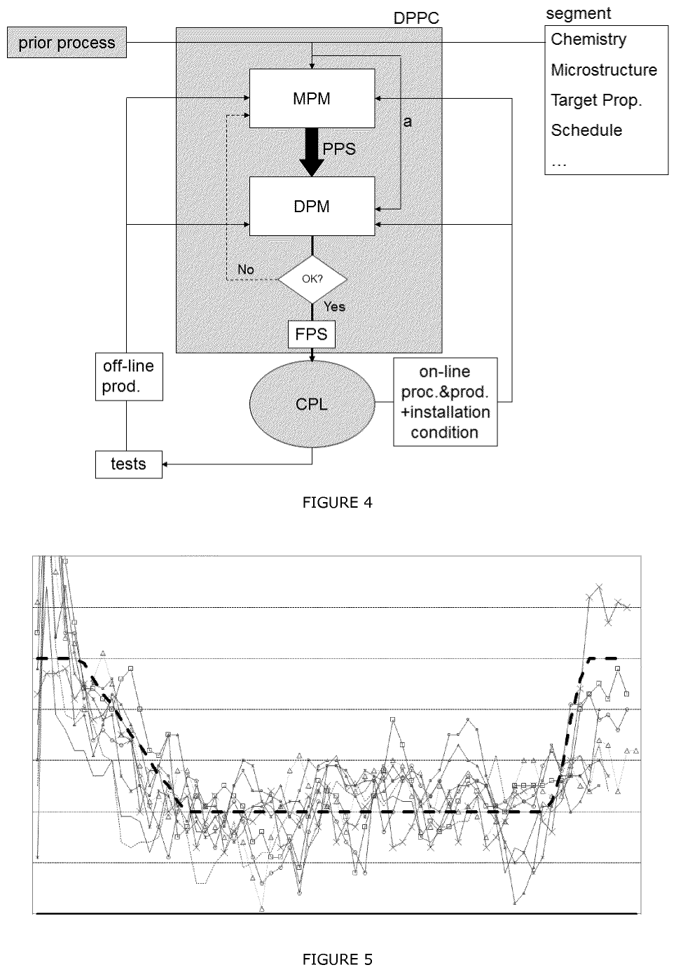

In FIG. 4 the DPPC is shown with the iteration depicted by the dashed line and it also shows the additional sources of input to the DPPC such as the results of off-line product tests, of on-line process and product measurements and installation condition. With these results both the DPM and the MPM can be improved.

In the method involving the Dynamic Property Predictive Control (DPPC) according to the invention the following steps can be distinguished:
a) collect and receive the inputs;
b) compute and predict the preliminary process settings and, if necessary, the resulting intermediate and final properties given the production schedule, the target properties and other inputs;
c) compute, validate and, if necessary, adjust the preliminary process settings given the production schedule, the installation conditions and other inputs;
d) iterate the steps b) and c) to optimise the preliminary process settings to maximise the satisfaction of the properties targets and operational targets, generate an exception notification when a target violation is foreseen and cannot be avoided;
e) calculate the final process settings for the forthcoming strips and transitions;
f) optionally collect and receive the process and property measurements and adapt the DPPC model, if necessary, to improve the accuracy of the DPPC models, or any one of the MPM or DPM.

In a cyclic operation as for real time control application, it starts with the step a) to gather the input relating to production schedule, feed stock (strip) properties and conditions as produced by the prior processes, and end product properties requirements and equipment condition and maintenance, available capacities etc., and provide them to the MPM and DPM for the iterative computation. The computation includes the steps b), c) and d) to maximise the satisfaction of the properties targets and operational targets. The process settings for the given production schedule are one of the outcomes of the computation. The final process settings are sent to the automation and/or control instrumentation system of the line. The exception notification is sent to the production unit that generates the production schedule for appropriate action or amendment of the schedule. Process condition measurements and intermediate and final property measurements (off-line and on-line) are regularly collected to adapt the parameters of the MPM and DPM. Preferably the cyclic operation is executed at least once per 30 minutes, preferably in a range from once per minute to once per second.

Conventional process control instrumentation is present in the CPL to measure process parameters such as line speed and temperatures to make sure that the FPS are realised.

The process settings can vary from strip to strip and from segment to segment within a strip. The calculation of the process settings of a particular strip or a segment of a strip is completed before the strip is loaded onto the de-coiler at the line entry, and preferably before the strip production sequence is confirmed. A re-calculation of the process settings is necessary when the production schedule or the inputs are changed, or when the actual process deviates beyond the tolerances of the latest issued process settings due to unforeseen equipment failures, manual intervention on the processing speed, etc.

The invention relates to a method for controlling a continuous processing line an annealing furnace to produce metal strip with excellent properties. It operates on a computerised system comprising:
data input including the production schedule containing multiple strips listed in production order, and of which the strip dimensions, the material chemistries, the entry conditions and in-strip spatial inhomogeneities as created by the prior processes (hot rolling, pickling and cold rolling, etc.), the end product properties and hence process requirements.
process models that describe and predict the states and dynamics of the installation and processes including the heat transfer during the annealing, the gas-metal reaction on the strip surface, the coating process (hot-dip galvanising, electroplating e.g.), the coating layer thickness regulation (zinc wiping process after the galvanising or current densities e.g.), the temper rolling, and/or the tension levelling.
material property models that describe and predict the intermediate and final state of the strip properties including the mechanical properties, the external/internal oxidation and surface wettability for galvanising or electroplating, and/or the geometry, using the conditions provided by the process models.
perform an optimisation algorithm by iteratively examining the processes prediction and the properties prediction to yield the process settings for the given production schedule. The process settings can vary from strip to strip and from segment to segment within a strip. The calculation of the process settings of a particular strip or a segment of a strip is completed before the strip is loaded onto the de-coiler at the line entry, and preferably before the strip production sequence is confirmed.
data output including the process settings to the automation and/or control instrumentation system of the line which then implements the settings and produces the segment of the steel strip with the target mechanical, surface and/or geometry properties.

By means of non-limiting examples, the following issues serve as illustrations of the capability of the DPPC:

For the annealing, the setting defines maximum and minimum temperatures determined by the required mechanical property norm, and target temperatures aiming to yield a more uniform property, considering the material chemistry, the entry conditions and in-strip spatial inhomogeneities produced by the prior processes (hot strip mill, pickling line, cold-rolling mill, etc.), and the predicted processing speed and (de-)accelerations. The minimum and maximum temperature settings also carry the constraints defined by the required shape and surface properties prior to the coating process, and the thermal dynamics during the strip transitions, etc.

For the processing (or strip) speed, the setting defines target speed, maximum and minimum limits determined by the required coating thickness and its control, the required mechanical property and its temperature-time control, the required surface roughness, the temper rolling reduction and its control, etc.

For the coating thickness, the setting defines the pressure of the wiping gas media, the distance between the gas jet outlet and the strip, the gas compressor head pressure determined by the required coating type and thickness, the required temper reduction and levelling elongation, the predicted processing speed and (de-)accelerations, etc.

For the surface conditioning prior to the galvanising, the setting defines the combustion air-to-fuel flow ratio, the oxygen concentration of the oxidation injection, the dew point of the furnace atmosphere, etc. determined by the material chemistry, the required galvanising bath chemistry, the predicted temperature evolution, the predicted processing speed, etc.

For the strip shape prior to the coating, the setting defines the temperature limits and maximum gradients for the (rapid) heating and cooling, the heating and cooling flux distribution over the strip width, the line tension, the none-flatness tolerance, etc. determined by the strip dimension (thickness to width ratio), the transport roll dimension, the required mechanical property and its temperature-time control, the predicted processing speed, the required coating thickness and its control, etc.

For the temper rolling and/or tension levelling, the setting defines the optimal reduction and/or elongation for an entire strip to maximise the prime quality, given the knowledge of the predicted annealing process, the predicted processing speed, the predicted inline shape, the material dimension, the required mechanical, geometry and surface properties.

It should be noted that the incoming rolled-strip may be hot-rolled strip, or cold-rolled strip. Hot-rolled strip is not normally subjected to further annealing, but in specific cases it may be necessary. For instance, if a hot-rolled strip is to be hot-dip coated, there is a need to heat the strip before dipping to avoid the metal dipping bath from cooling down below the operating temperature. This is usually referred to as the heat-to-coat process. There is no need to heat the strip to affect the properties, such as in recrystallisation and/or austenitisation annealing of cold-rolled strip. On the other hand, for hot-rolled steels containing certain microstructures such as martensite or for hot-rolled steels which still have a potential for precipitation hardening because of dissolved elements, an annealing treatment may be beneficial to temper the martensite and improve the ductility of the steel, or to promote the precipitation and improve the strength of the steel.

In a preferable embodiment the incoming steel strip is a cold-rolled steel. This is the most common form to be annealed in a CPL according to the invention and these steels have to be produced against ever tightening tolerances and ever increasing demands as to the number of allowable defects, the mechanical properties, the surface quality and the dimensions and dimensional tolerances.

In a cyclic operation as for real time control application, the process settings for the given production schedule are automatically calculated and sent to the automation and/or control instrumentation system of the line. The exception notification is generated if a target violation is foreseen and sent to the scheduling unit that generates the production schedule.

Preferably a re-calculation of the process settings is automatically triggered when the production schedule or the inputs are changed, or when the actual process deviates beyond the tolerances of the latest issued process settings due to unforeseen equipment failures, manual intervention on the processing speed, etc.

The invention is also embodied in a computerised process automation for a continuous processing line, wherein the process automation is embodied such that, during operation, it carries out a method according to the invention.

The invention is also embodied in a continuous processing line which is controlled by a computerised process automation according to the invention, and in a continuous processing line in which, during operation, the FPS for a segment of incoming steel strip are determined, set and realised by the CPL computerised process automation, according to the invention to enable production of a segment of the steel strip with the target mechanical, surface and/or geometry properties.

The invention's usefulness is demonstrated by means of the following, non-limiting, example and figures.

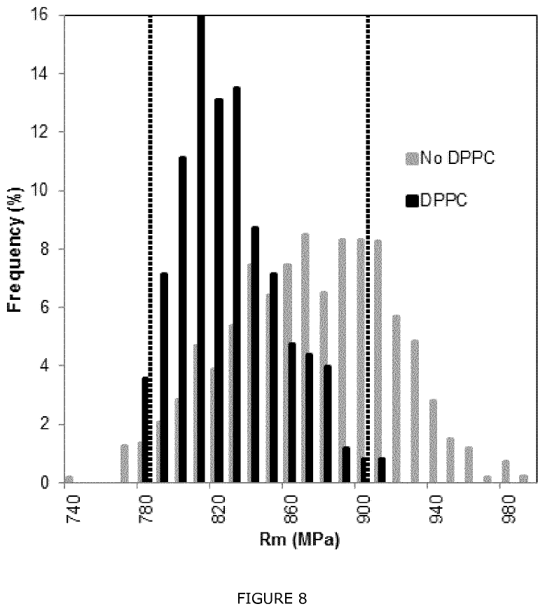

FIGS. 7 and 8 show measurements of the mechanical properties of a galvanised high strength steel grade produced from a continuous processing line. In light grey the results without DPPC are depicted. In black the results for the same steel produced with a version of the DPPC are depicted. The depicted mechanical properties are the yield stress (Rp) and the tensile strength (Rm). The properties without DPPC show a wide distribution with a significant degree of measurements outside the tolerance (dashed vertical lines). 35% would have been rejected on Rp (FIG. 7) and 30% on Rm (FIG. 8). The DPPC predicted that significant improvements would be made by adapting the annealing regime with consideration of the coiling temperature regime realised in the run-out-table cooling of hot strip mill (HSM).

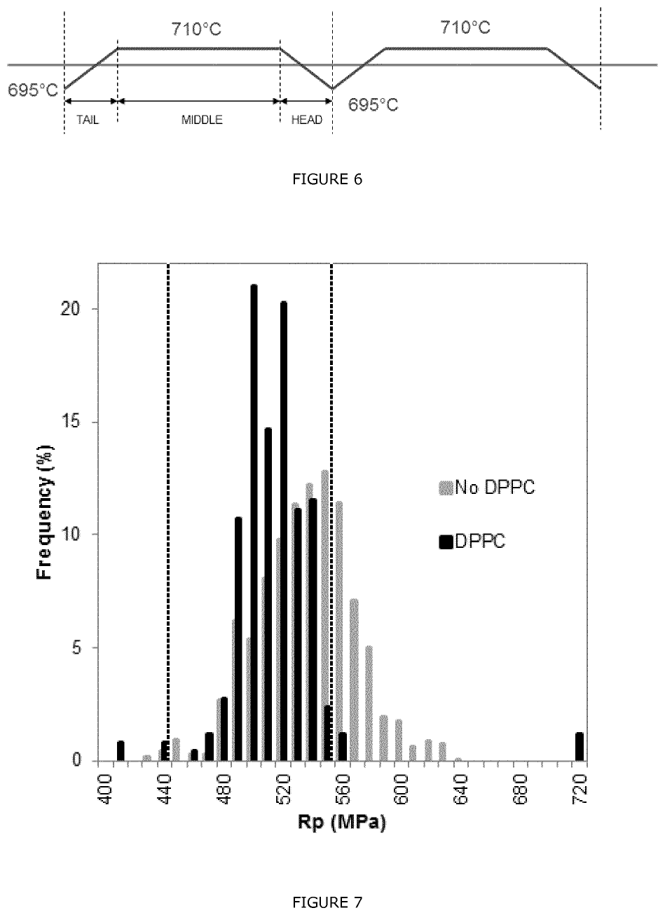

A controlled coiling temperature was used where head and tail of the hot-rolled strip are coiled at a higher temperature to compensate for the faster cooling rate at the outer wraps of the hot-rolled coil. FIG. 5 shows the temperature against the normalised length for a large number of strips. These hot-rolled and U-type cooled strips were subsequently pickled and cold-rolled. In addition thereto, by taking into account the in-strip spatial inhomogeneity realised from the prior process steps, the DPPC proposed a lower annealing temperature for the head and tail of the cold-rolled strip of these hot-rolled coils compared to the middle segment(s) of the strip. This is schematically depicted in FIG. 6. The horizontal line at around 705° C. represents the prior art practice of an equal annealing temperature over the entire length of the strip. The rapid heating furnace of the annealing step in the said processing line subsequently imposed this temperature regime onto the cold-rolled strips and the results of the final product are given in black in FIGS. 7 and 8. These values show a significantly reduced width of the distribution as well as a much better performance against the tolerance. The rejection rate on Rp dropped to 5% and on Rm to 2%.

1. A method for operating a continuous processing line (CPL) comprising an continuous annealing step for the production of continuously processed rolled steel strip using a computer aided dynamic property predictive control model (DPPC) comprising a material property model (MPM), which predicts a set of preliminary process settings (PPS) with which the target mechanical, surface and geometry properties for a segment of strip can be obtained according to the MPM, and a dynamic process model (DPM), which determines whether these PPS can be realised in the CPL, wherein the output of the MPM is used as input parameters for the DPM to enable the DPM to provide final process settings (FPS) for the CPL, wherein the input parameters for the MPM comprise:
one or more elements of the production schedule, which is the succession of strips that are to be produced, wherein each strip has its own set of properties such as strip dimensions, the chemical composition, the entry conditions and in-strip spatial inhomogeneities as created by the prior processes, the target mechanical, surface and geometry properties
target values for a segment of the incoming rolled strip for the mechanical, surface and/or geometry properties
one or more parameters of prior process conditions and/or predicted or measured mechanical, surface and/or geometry properties of said segment
optionally one or more elements of the chemical composition of said segment of the steel strip
optionally one or more microstructural parameters of said segment of the incoming rolled strip
optionally installation condition parameters
optionally feedback parameters from on-line property measurements of the incoming rolled strip
optionally feedback parameters from off-line property measurements and wherein the input parameters for the DPM comprise
the output of the MPM
and one or more of:
installation condition parameters
one or more of the input parameters for the MPM
feedback from on-line CPL process measurements
to produce the FPS for the segment of the steel strip and wherein the FPS for the segment are fed into the CPL computerised process automation, whereby the segment of the steel strip is subsequently produced satisfying the target mechanical, surface and/or geometry properties.

2. The method according to claim 1, wherein the FPS for the segment are optimised in an iterative process wherein the output of the DPM is fed back into the MPM for the next iteration until the difference between the target mechanical, surface and/or geometry properties of the segment and the achievable mechanical, surface and/or geometry properties of the segment has reached a pre-set minimum.

3. The method according to claim 1, wherein the incoming rolled strip is a hot-rolled strip.

4. The method according to claim 1, wherein the incoming rolled strip is a cold-rolled strip.

5. The method according to claim 1, wherein the continuous processing line further comprises one or more of:
a first coating process step
a temper-rolling and/or tension levelling process step
a second coating process step
a post-processing step

6. The method according to claim 5, wherein the first and/or second coating step is a hot-dip coating process or an electroplating process.

7. The method according to claim 5, wherein the DPPC also provides the FPS for the CPL automation of the thickness control of the coating layer.

8. The method according to claim 5, wherein the first and/or second coating process step is an organic coating step.

9. The method according to claim 5, wherein the first and/or second coating process step is an inorganic coating step.

10. The method according to claim 1, wherein a re-calculation of the process settings is performed when the production schedule or the input parameters for the DPPC are changed.

11. The method according to claim 1, wherein the re-calculation of the process settings is performed at least once per 30 minutes.

12. A method for computerised process automation for a continuous processing line, wherein the computerised process automation, during operation, carries out a method according to claim 1.

13. A continuous processing line which is controlled by a method for computerised process automation according to claim 12.

14. A continuous processing line in which, during operation, the FPS for a segment of incoming steel strip are determined, set and realised by the CPL computerised process automation method, according to claim 12 to enable production of a segment of the steel strip satisfying the target mechanical, surface and/or geometry properties.

15. The continuous processing line according to claim 13 in which, during operation, the FPS for a segment of incoming steel strip are determined, set and realised by the CPL computerised process automation method, to enable production of a segment of the steel strip satisfying the target mechanical, surface and/or geometry properties.

16. The method according to claim 5, wherein the first and/or second coating process step is physical vapour deposition (PVD).
